(19) United States
(12) Patent Application Publication
(10) Pub. No.: US 2009/0102679 A1
(43) Pub. Date: Apr. 23, 2009

(54) Infrastructure device with removable face plate for remote operation

(75) Inventor: Roland Schoettle, American Canyon, CA (US)

Correspondence Address: OPTIMAL TECHNOLOGIES, INC., TWO PROGRESS PLAZA, 100 EAST DAVIE STREET, 19TH FLOOR, RALIEGH, NC, 27601, US

(73) Assignee: Optimal Innovations Inc., Bridgetown (BB)

(21) Appl. No.: 11/875,726

(22) Filed: Oct. 19, 2007

(51) Int. Cl. G08B 5/00

(52) U.S. Cl. 340/815.4

(57) ABSTRACT

The present invention is directed to a utility device faceplate that allows a user to change its orientation with respect to the user. In one embodiment, the orientation is a swivel up, down or from side to side so as to present the front surface of the faceplate substantially perpendicular to the user regardless of the orientation of the device or the wall that contains the utility box it is mounted within. In another embodiment, the faceplate can be removed and viewed and/or operated from a location remote from the physical location of the utility device to which it pertains. In one embodiment, the faceplate anticipates the user's position and adjusts itself to accommodate the user.

### CROSS-REFERENCE TO RELATED APPLICATIONS

This application is related to U.S. patent application Ser. No. 11/683,298 filed Mar. 7, 2007 entitled “LIGHT SWITCH USED AS A COMMUNICATION DEVICE”; U.S. patent application Ser. No. 11/683,326 filed Mar. 7, 2007 entitled “ANTICIPATORY UTILITY CONTROL DEVICE”; U.S. patent application Ser. No. 11/683,335 filed Mar. 7, 2007 entitled “PLUG AND PLAY UTILITY CONTROL MODULES”; U.S. Provisional Patent Application No. 60/956,314 filed Aug. 16, 2007 entitled “UTILITY OUTLETS AS A SECURITY SYSTEM”; U.S. Provisional Patent Application No. 60/940,010 filed May 24, 2007 entitled “LIGHT SWITCH AS A WIRELESS HUB”; U.S. Provisional Patent Application No. 60/940,010 filed May 24, 2007 entitled “UTILITY OUTLETS AS REMOTE CONTROL REPEATERS”; U.S. Provisional Patent Application No. 60/956,306 filed Aug. 16, 2007 entitled “USING UTILITY OUTLETS TO DETERMINE AND REPORT MEDIA-BASED ACTIVITY”, and U.S. patent application Ser. No. ______ filed Oct. 19, 2007, Attorney Docket No. 66816-P035US-10715040 entitled “SIZE UNCONSTRAINED FACEPLATE DISPLAY FOR USE WITH INFRASTRUCTURE DEVICE,” the disclosures of which are incorporated herein by reference.

### TECHNICAL FIELD

This disclosure relates to infrastructure devices and more particularly to faceplate displays for such devices that are not rigidly affixed to the infrastructure.

### BACKGROUND OF THE INVENTION

Infrastructure devices are those devices that are mounted to a premises in such as manner as to be permanent or at least not easily removed there from. One aspect of an infrastructure device is that it is connected, at least electrically, to wiring affixed to the premises structure. Another aspect of an infrastructure device is that it is connected via wired or wireless communications to devices that are themselves connected electrically to the premises electricity delivery infrastructure. A light switch is one form of an infrastructure device. An electrical outlet is another form of such a device. A TV, radio, security system, surveillance system, premise-based communication system, or game box is yet another form of such device. Other infrastructure devices can be, for example, a wide variety of sensors/systems such as light sensors, temperature sensors, internet access systems, WAN system, LAN systems, RF systems, display systems, power sensors, power supply systems, schedulers, clocks, audio/video systems, intercom systems, telephone systems, HVAC systems, television, radio, cameras, proximity sensors, occupancy sensors, GPS, entertainment systems, safety monitoring systems, security systems, fire monitoring systems, surveillance systems, messaging systems, alert and alarm systems, medical monitoring systems, data monitoring systems, data control systems, access monitoring systems, access control systems, legacy remote control systems (e.g., TVs, radios, lighting), media reader systems, identification systems, humidity sensors, barometric pressure sensors, weight sensors, traffic pattern sensors, power quality sensors, operating costs, power factor sensors, meters, storage systems, distributed generation systems, UPS systems, battery monitoring systems, priority systems, inertia sensors, glass break sensors, flood sensors, vibration sensors, smoke sensors, carbon dioxide sensors, carbon monoxide sensors, ultrasound sensors, infra-red sensors, microwave sensors, radiation sensors, bacteria sensors, disease sensors, poison sensors, germ sensors, toxic material sensors, air quality sensors, laser sensors, load sensors, load control systems, etc.

A common trait of infrastructure devices, such as switches and electrical sockets, is that they are typically mounted in boxes, usually called utility boxes, permanently (for all practical purposes) affixed to the premises. Utility boxes come in various sizes with the smallest size (single gang) having a front opening of roughly 2½ inches wide and 4 inches tall. Utility boxes typically grow larger in the width direction. Thus a two-gang utility box has the same height (4 inches) but a width of 5 inches, with a triple-gang box having a width of 7½ inches, etc.

Utility device covers, called faceplates, typically are supported on the front of each utility box by fastening the faceplate to the device that is mounted within the utility box. Several problems exist with such an arrangement when the faceplate, in addition to presenting a finished appearance to an otherwise utilitarian device, displays information useful to a user. Problems with display devices arise when the user is not able to approach the display from directly in front of the permanently mounted device. This could occur, for example, with small children, people in wheelchairs or with tall persons. This could also occur when the utility device is positioned in a side wall over a counter so that in order to see the device from a straight-on angle the user would have to bend over the counter. Another difficult situation is when the user is unable to get close enough to the device to read the information being displayed. All of these situations present some degree of difficulty when utility device covers are used for displaying useful information to the user.

A related problem arises when the user desires to operate the display, such as, for example, to turn a light on or off, or to change the temperature, or to use the device as an intercom, the display will be out of the reach of the user. The permanent positioning of the utility device faceplate requires that the user be able (or desire) to get close enough to manipulate input keys or switches on the device. Again, the position of the mounted device, either above or below the physical reach of the user, or across the room from the user or around a corner, inhibits easy device operation.

### BRIEF SUMMARY OF THE INVENTION

The present invention is directed to a utility device faceplate that allows a user to change its orientation with respect to the user. In one embodiment, the orientation is a swivel up, down or from side to side so as to present the front surface of the faceplate substantially perpendicular to the user regardless of the orientation of the device or the wall that contains the utility box it is mounted within. In another embodiment, the faceplate can be removed and viewed and/or operated from a location remote from the physical location of the utility device to which it pertains. In one embodiment, the faceplate anticipates the user's position and adjusts itself to accommodate the user.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIGS. 1 and 1A show one embodiment of a utility device faceplate monitor in accordance with the invention;

FIGS. 2A through 2C are embodiments of the faceplate shown in various orientations relative to the device;

FIG. 3 illustrates embodiments of utility devices mounted in a premises;

FIGS. 4, 5 and 5A show the front and rear surfaces, respectively, of one embodiment of a movable faceplate monitor;

FIG. 6 shows one embodiment of an expandable faceplate monitor;

FIG. 7 shows one embodiment of a monitor that can be moved from direct physical connection with its associated utility device; and

FIGS. 8 and 9 show operation aspects of the invention.

### DETAILED DESCRIPTION OF THE INVENTION

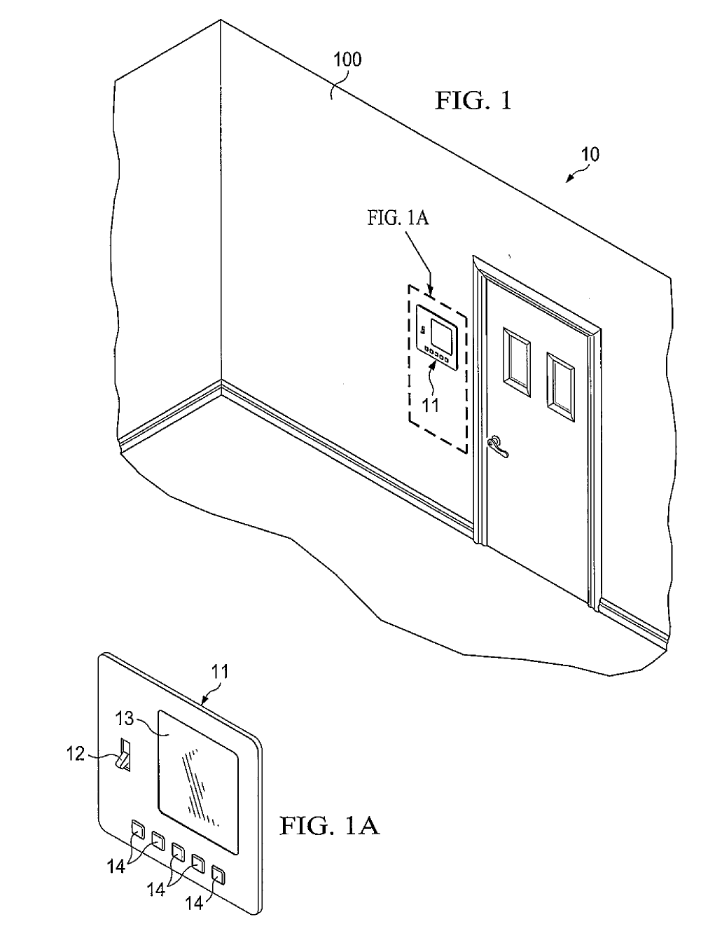

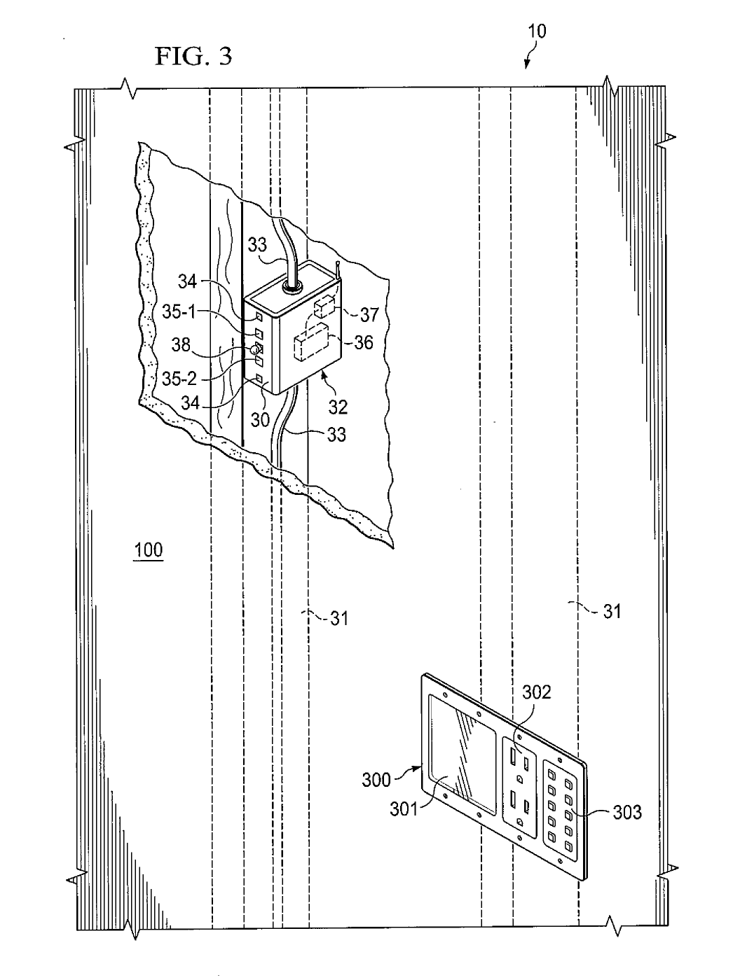

FIGS. 1 and 1A show one embodiment 10 of a utility device faceplate monitor, such as monitor 11, in accordance with the invention. As shown, monitor 11 has on-off switch 12 as well as display 13 and keys 14. Monitor 11 can have any type of configuration desired such that a user (not shown) can operate one or more utility and/or utility-connected devices. Switch 12 can be a traditional switch with a toggle that is moved from one position to another, or switch 12 can be a touch sensitive switch or even a “soft” switch that is displayed only during those periods of time when the function of the monitor (which can change from time to time) is set to control a light fixture, usually also permanently mounted to the premises. Display 11 is designed for use with a premises utility device. Such as device 30 FIG. 3) mounted in a utility box, such as box 32 (FIG. 3).

Display 13, as well as keys 14, and any other arrangement of keys and switches can be changed from time to time as desired to operate the utility devices, or to receive information from the devices or from a network associated with the devices. In this context any type of device that is primarily associated with premises operation or services delivered to users in premises or environmental conditions in or pertaining to the premises is a utility device and/or service.

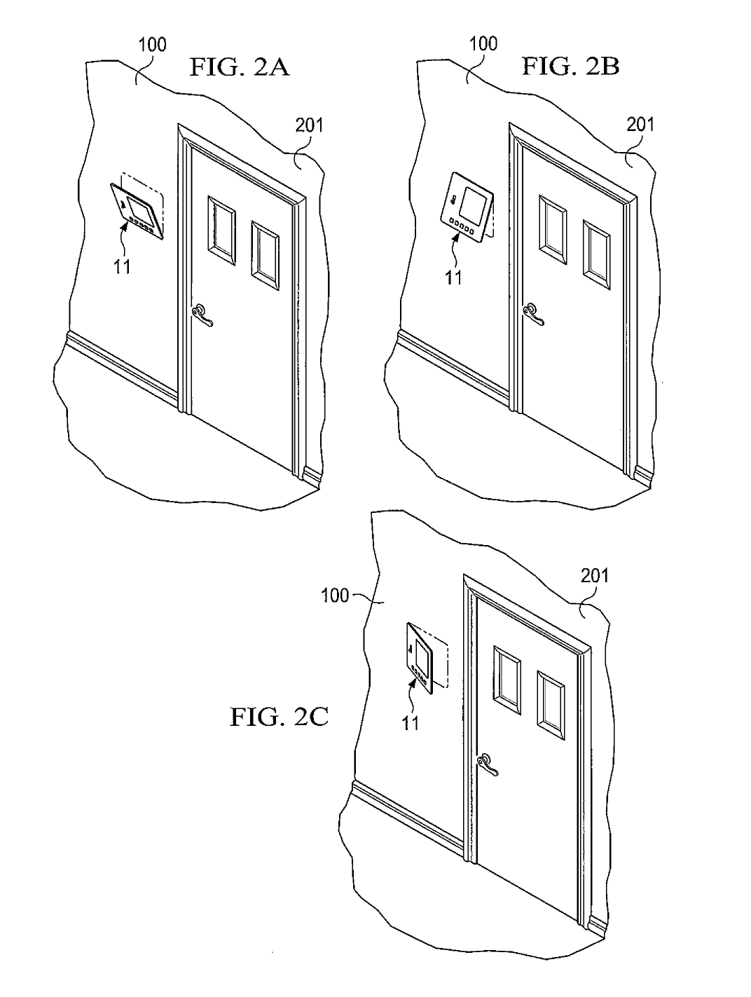

FIGS. 2A through 2C are embodiments of the faceplate shown in various orientations relative to the device. FIG. 2A shows monitor 11 tilted downward such that its front surface 21 is no longer parallel to the surface of face 201 of wall 100. In one embodiment, the user can simply rotate monitor 11 downward. Monitor 11 then pivots around one or more bearing points, such as bearing point 38 formed by ball hinge 38 mating with ball hinge 58 (FIG. 5).

FIG. 2B shows faceplate monitor 11 tilted upward while FIG. 2C shows the monitor tilted to the right. If desired, the movement of monitor 11 can be facilitated without having the user physically touching the monitor, much as an automobile side mirror is movable Piston(s) 59-1 and/or 59-2 (FIG. 5) show one embodiment of up/down/side to side movement control without requiring the user to physically touch the mirror.

If desired, a processor in the monitor (or in the associated utility device) can control the movement of the monitor based upon anticipated needs of the user. These needs can be anticipated from prior actions of the user as contained in a database, or form a next anticipated operation of the monitor based upon a state machine controlling the monitor.

FIG. 3 illustrates embodiments of utility devices mounted in a premises. As shown, utility box 32 is mounted to stud 31 and premises wiring 33 is coming into and out of the utility box. Note that while this is 110 or 220 AC voltage, it could also be low voltage, cat5e, thermostat or any other type or combination of wiring. Utility box has mounted therein a utility control device, such as device 30. Device 30 would typically be connected electrically or wirelessly with one or more particular premises devices, such as lights, thermostats, speakers, audio/video systems, intercoms, voice systems, video cameras, video displays, electrical outlets, such as outlet 302 associated with monitor 300.

Device 30 also has associated therewith a controller, such as controller 36 and a send/receive device 37. Transmitter/receiver 37 can communicate with other utility devices within and outside of the premises or with one or more faceplate monitors as will be discussed hereinafter.

Faceplate 300 is shown in association with outlet 302 and contains display 301 and keys 303. Note that if faceplate 300 is reoriented outlet 302 (as could light switch 12 with respect to faceplate 11) could move with the faceplate in one embodiment or it could remain stationary. As discussed above, the reorientation can be under physical control of a user or anticipated for the user.

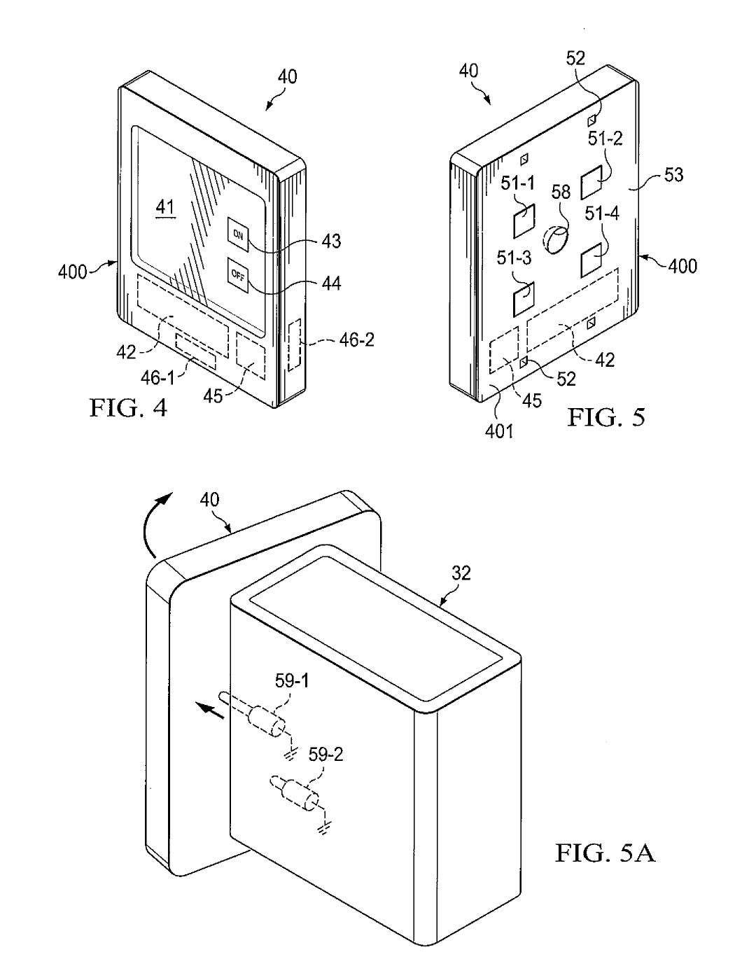

FIG. 4 shows the front surface of one embodiment of a movable faceplate monitor, such as monitor 40. Display 41 shows a “soft” on button 43 and a soft off button 42 as well as processor 42 for controlling operation of the faceplate. Also shown is transmitter/receiver 45 operative for communication between the faceplate monitor and the associated utility box, such as utility box 32, FIG. 3.

FIG. 5 shows rear surface 53 of movable faceplate monitor 40. Shown are contacts, such as contacts 51-1 to 51-4, for mating with the utility device when the monitor and the device are physically together. Also shown is portion 58 of the ball joint that, in one embodiment, allows the monitor front surface to be positionally reconfigured from time to time with respect to the surface to which the associated utility device is mounted. Pistons 59-1 and 59-2, shown in conjunction with box 32 in FIG. 5A, show one embodiment of a mechanism for allowing automatic orientation of the monitor without physical involvement of the user. Note that in some embodiments there would be a housing mounted external to utility box 32 and the monitor in turn would be mounted within that housing. The housing would contain the mechanism to allow the display to move relative to the surface of the premises while the outer perimeter of the housing remains stationary. Thus, the display would rotate much as the side mirrors of an automobile mirror rotates within a housing framework.

In one embodiment, contacts 51-1 to 51-4, shown in FIG. 5, are used for mating with contacts, such as contacts 15-1, 15-2 (FIG. 1) located in the mated utility box. Note that communication between the faceplate and the utility box (or devices within the utility box) can be by electrical contact as shown or wirelessly by RF, optics or any other method. When the monitor is in contact with the utility box, the box can charge electrical storage (battery, capacitor, etc.) within the monitor. This can be done with electrical contact or under some conditions, wirelessly.

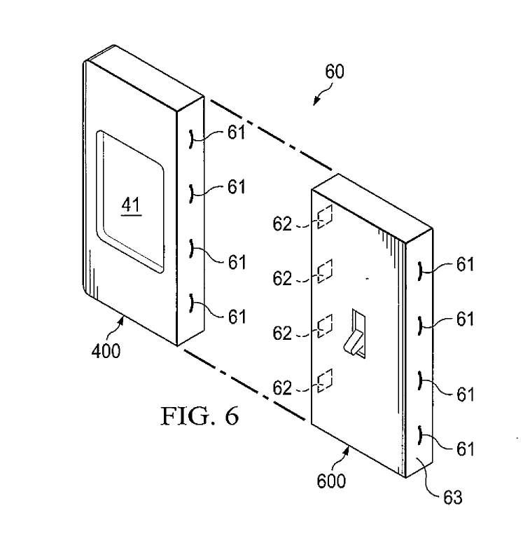

FIG. 6 shows system 60 in which two faceplates are mated side by side to form a double width faceplate. Note that while each of these faceplates is shown as a single-gang width faceplate, they can be any width desired and any number of widths can be added as desired. Multiple faceplates can thus be combined to form a unified faceplate having an expanded width to allow for necessary electronics and display size that fits the intended usage. The faceplates can be, for example, connected together using male/female clips 61, 62, as shown, or by using any other connecting mechanism. A cover (not shown) can be used to cover the open ends, such as open end 63, to hide the unused clips. The monitor can be any size or shape desired to work with any size utility box or utility device(s) and to fit the décor or physical limitations of the premises. The monitor could be tall or wide, or round or have any shape desired. When the display is on the utility box, it could have a first orientation and when it is away from the utility box, it could be turned into a different orientation and the display could sense the rotation (using rotation sensors, such as sensors 46-1, 46-2, FIG. 4) and adjust accordingly.

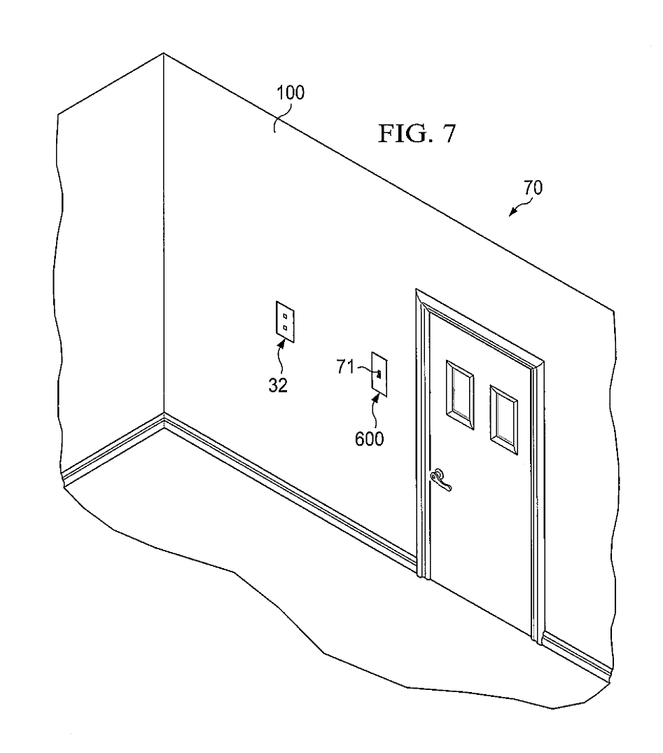

FIG. 7 shows one embodiment of a monitor, such as monitor 11, that can be physically relocated from direct physical contact with its associated device. As shown, utility device 32 remains fixed to premises 100 at its original location. However, faceplate monitor 11 has been removed by the user and is available for relocation under control of the user. The faceplate, using its wireless transmitting/receiving capability, continues to operationally function from whatever location it is placed in by the user. This remote operation can also be effectuated by plugging the relocated faceplate monitor into another utility outlet so that communication back to the associated utility device is over the premises wiring.

Note that when a monitor is removed from its originally associated (home) utility device it continues to perform functions only with respect to that home utility device regardless of where the user places the device. In this regard, the monitor acts with respect to the home device as a remote acts with respect to a TV or DVR.

In one embodiment, as shown in FIG. 7, the user could register the removed monitor for use with a utility device other than (or in some cases, instead of) the home device. This registration can be effected by entering a code in the removed monitor, or by bringing the monitor into proximity to the “neighbor” device and activating a communication exchange, or by any of several other methods of registration. One such method could be, for example, one or more of the methods currently used by universal TV remotes for multiple device control.

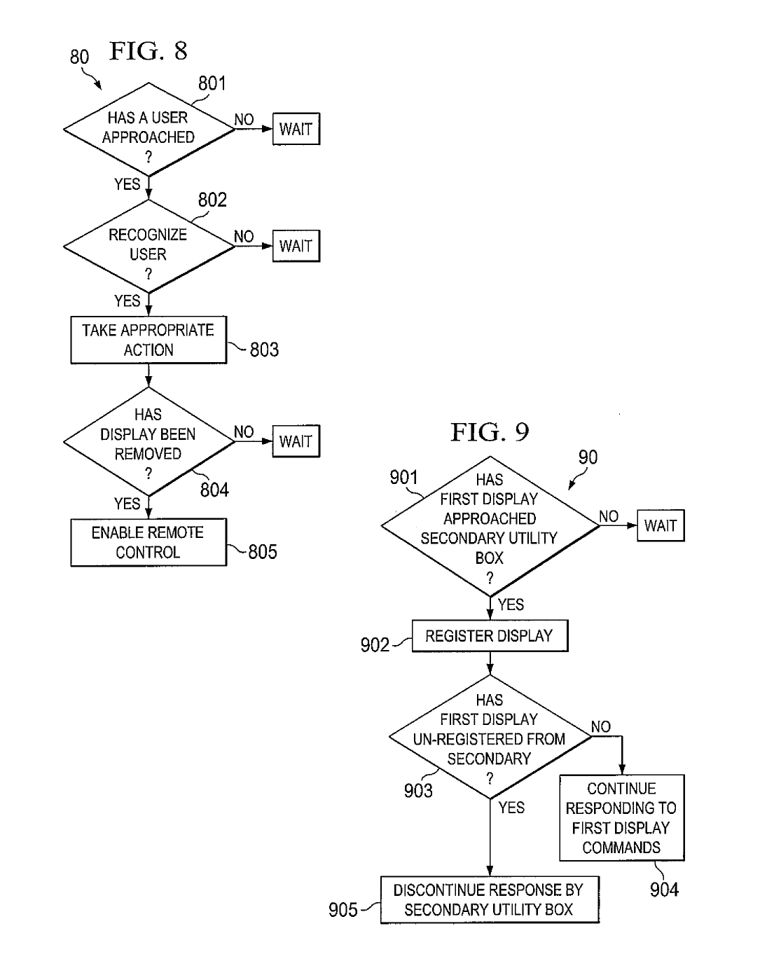

FIGS. 8 and 9 show operation aspects of the invention. Process 80, shown in FIG. 8, determines if a user has approached a particular monitor. In one embodiment, the monitor, or the device to which the monitor is associated (the home device) determines, as discussed above, if the user is recognized, or if a next appropriate action is recognized. If so, process 803 takes the appropriate action. In some situations, this would mean that the display front surface becomes reoriented with respect to the user, or with respect to the wall surface upon which it is attached. For example, the monitor, upon sensing the presence of a user, tilts or twists such that its faceplate front surface always faces the user even if the user is moving. Motion sensors and position sensors anticipate movement, algorithms can be combined under control of the monitor's (or device's) processor to control the movement of the faceplate.

Process 804 determines if the monitor has been removed from its home device. If it has, then process 805 enables the monitor to work wirelessly with the home unit and to perform any function remotely that could have been performed while the monitor was attached physically to the home device. This remote operation continues until the monitor is retuned into physical contact with its home device. At that point process 805 causes process 806 to switch back to attached mode. Note that the monitor may always operate in the same mode whether or not it is physically co-located with the home device or remote therefrom, if desired.

Process 901, FIG. 9, determines if a display that is separated from its home device (a first display in our example) desires to become associated, at least temporarily, with a second utility device. If so, the first display is registered with the second device via process 902 and from that point, until deregistration, the first monitor can control functions at and through the second device. As discussed above, this registration can be accomplished in any of a number of ways, including different frequencies or codes selected by the device or the monitor.

Process 903 determines if the monitor from the first device has unregistered with the second device. If so, process 904 discontinues the second device from responding to communications from the first device's associated monitor. Note that the first monitor could, if desired, become associated with a second (or more) other devices even while physically attached to its home device. This will allow for temporary remote operation by a monitor at one location being able to control operations at a device physically separate therefrom.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A utility device faceplate comprising:
a display area for presenting functions of an associated utility device to a user; and means for allowing said faceplate to move relative to said associated utility device while said display area remains active for presenting said functions of said associated device.

2. The device of claim 1 wherein said faceplate movement is articulation.

3. The device of claim 2 further comprising:
means for effecting said articulation without physical contact by said user.

4. The device of claim 3 wherein said effecting means comprises:
means for anticipating a user's presence.

5. The device of claim 3 further comprising:
means for determining an identity of a particular user based upon pre-stored data.

6. The device of claim 1 wherein said faceplate movement is separation from said associated device.

7. The device of claim 6 wherein said device further comprises:
at least one sensor for accepting input from a user; and
means for communicating accepted user inputs to said associated device from a faceplate separated from said associated device so as to allow said associated device to effectuate said user input.

8. The device of claim 7 wherein said communicating means comprise wireless transmission between said utility device and said faceplate.

9. The device of claim 8 further comprising:
means for communicating accepted user inputs to said associated device from a faceplate not separated from said associated device so as to allow said associated device to effectuate said user input, said last-mentioned communication means being a hard-wired connection between said faceplate and said associated device.

10. The device of claim 9 further comprising:
means for charging an electricity storage system within said faceplate while said faceplate is not separated from said associated device.

11. The device of claim 6 further comprising:
means for registering a separated monitor for use with at least one utility device other than a utility device from which said monitor has been separated

12. The device of claim 1 wherein said presented functions comprise at least one selected from the list of: light switch, temperature, internet, light display, light levels, power usage, user selectable display, time, schedules, communication parameters (LAN/WAN), network parameters, audio/video, intercom, telephone, thermostat, HVAC, television, radio, camera, proximity sensor, occupancy sensor, GPS, entertainment, safety monitoring, security monitoring, fire monitoring, surveillance, messaging, alerts and alarms, medical monitoring, data monitoring, data control, access monitoring, access control, legacy remote control (e.g., TVs, radios, lighting), media readers, identification, humidity, barometric pressure, weight, traffic patterns, power quality, cost, power factor, metering, storage status, storage control, DG control, DG monitoring, UPS control, UPS monitoring, battery monitoring, priority, inertia, glass break, flood, vibration, smoke, carbon dioxide, carbon monoxide, ultrasound, infra-red, microwave, radiation, bacteria, disease, poison, germs, toxic materials, air quality, laser, load, load control.

13. The device of claim 1 wherein said faceplate can be any area selected by a user.

14. The device of claim 1 wherein a physical orientation of said faceplate determines a data display orientation.

15. A method of using a utility device monitor, said utility device attached to a structure of a premises; said method comprising:
adjusting a front surface of said monitor to accommodate physical needs of a user, said adjusting performed on a user by user basis.

16. The method of claim 15 wherein said adjusting is articulation of said front surface relative to a surface of said structure.

17. The method of claim 16 further comprising:
effecting said adjusting based upon anticipated needs of said user.

18. The method of claim 16 further comprising:
identifying said user based upon pre-stored user identification characteristics.

19. The method of claim 16 further comprising:
effecting said adjusting based upon input from internal sensors as well as external sensors; said sensors selected from the list of: light switches, light sensors, temperature sensors, thermostats, internet access systems, WAN system, LAN systems, RF systems, display systems, power sensors, power supply systems, schedulers, clocks, audio/video systems, intercom systems, telephone systems, thermostats, HVAC systems, television, radio, cameras, proximity sensors, occupancy sensors, GPS, entertainment systems, safety monitoring systems, security systems, fire monitoring systems, surveillance systems, messaging systems, alert and alarm systems, medical monitoring systems, data monitoring systems, data control systems, access monitoring systems, access control systems, legacy remote control systems (e.g., TVs, radios, lighting), media reader systems, identification systems, humidity sensors, barometric pressure sensors, weight sensors, traffic pattern sensors, power quality sensors, operating costs, power factor sensors, meters, storage systems, distributed generation systems, UPS systems, battery monitoring systems, priority systems, inertia sensors, glass break sensors, flood sensors, vibration sensors, smoke sensors, carbon dioxide sensors, carbon monoxide sensors, ultrasound sensors, infra-red sensors, microwave sensors, radiation sensors, bacteria sensors, disease sensors, poison sensors, germ sensors, toxic material sensors, air quality sensors, laser sensors, load sensors, load control systems.

20. The method of claim 15 wherein said adjusting is removing said monitor from said utility device while said monitor continues to function with respect to said device.

21. The method of claim 20 further comprising:
wirelessly transmitting commands between a removed monitor and a utility device from which said monitor has been removed.

22. The method of claim 20 further comprising;
registering a removed monitor for use with at least one utility device other than a utility device from which said monitor has been removed.
